(19) United States
(12) Patent Application Publication
(10) Pub. No.: US 2012/0230176 A1
(43) Pub. Date: Sep. 13, 2012

(54) RECEIVE BAND NOISE CANCELLATION METHOD AND APPARATUS

(75) Inventors: Christos Komninakis, San Diego, CA (US); Joseph Patrick Burke, Glenview, IL (US); Daniel Fred Filipovic, Solana Beach, CA (US)

(73) Assignee: QUALCOMM INCORPORATED, San Diego, CA (US)

(21) Appl. No.: 13/413,902

(22) Filed: Mar. 7, 2012

Related U.S. Application Data
(60) Provisional application No. 61/449,782, filed on Mar. 7, 2011.

(51) Int. Cl. H04B 15/00

(52) U.S. Cl. 370/201

(57) ABSTRACT

A method and apparatus for eliminating receive band noise in a communication system is provided. The method comprises sensing a transmit signal at a receive frequency, wherein the signal sensed is a bleed over signal from a transmit signal. The sensed bleed over signal is then digitized using a secondary receiver. This secondary receiver utilizes a separate path from the primary receive path. The next step in the method is to estimate the linear distortion, delay, attenuation in the sensed bleed over signal. Next, compensation for the linear distortion, delay, and attenuation are performed on the sensed bleed over signal. The sensed, digitized, and compensated bleed over signal is then cancelled from the primary receive path.

### CROSS-REFERENCE TO RELATED APPLICATIONS

This application claims the benefit of U.S. Provisional Patent Application No. 61/449,782, entitled “RxBN Cancellation Via FB,” filed on Mar. 7, 2011, which is expressly incorporated by reference herein in its entirety.

### BACKGROUND

1. Field

The present disclosure relates generally to communication systems, and more particularly, to canceling noise in the receive channel.

2. Background

Wireless communication systems are widely deployed to provide various types of communication content such as voice, data, and so on. These systems may be multiple-access systems capable of supporting communications with multiple users by sharing the available system resources (e.g., bandwidth and transmit power). Examples of such multiple-access systems include code division multiple access (CDMA) systems, time division multiple access (TDMA) systems, frequency division multiple access (FDMA), 3GPP Long Term Evolution (LTE) systems, and orthogonal frequency division multiple access (OFDMA) systems.

Generally, a wireless multiple-access communication system can simultaneously support communication for multiple wireless terminals. Each terminal communicates with one or more base stations via transmissions on the forward and reverse links. The forward link (or downlink) refers to the communication link from the base stations to the terminals, and the reverse link (or uplink) refers to the communication link from the terminals to the base stations. This communication link may be established via a single-in-single-out, multiple-in-single-out or a multiple-in-multiple-out (MIMO) system.

A MIMO system employs multiple (N_{T}) transmit antennas and multiple (N_{R}) receive antennas for data transmission. A MIMO channel formed by the N_{T} transmit and N_{R} receive antennas may be decomposed into N_{S} independent channels, where N_{S}≧min{N_{T}, N_{R}}. Each of the N_{S} independent channels corresponds to a dimension. The MIMO system can provide improved performance (e.g., higher throughput and/or greater reliability) if the additional dimensionalities created by the multiple transmit and receive antennas are utilized.

A MIMO system may support time division duplex (TDD) and/or frequency division duplex (FDD) systems. In a TDD system, the forward and reverse link transmissions are on the same frequency region so that the reciprocity principle allows the estimation of the forward link channel from the reverse link channel. This enables the base station to extract transmit beamforming gain on the forward link when the multiple antennas are available at the base station. In an FDD system, forward and reverse link transmissions are on different frequency regions.

Modern cellular phones support multiple carriers and modes of operation. In operation multiple synthesizers are turned on at the same time, and each synthesizer is tuned to a specific carrier frequency. Transceiver size is shrinking. Internally, this forces the required multiple synthesizers to support multi-carrier operation to be close together, in many cases, within the same RF die.

A drawback of the design is that the close proximity of the strong transmit signal creates noise in the receive channel by spectral leakage. This may obscure the desired receive signal and make operation difficult.

There is a need in the art for mitigating the problem of cancelling noise in the receive channel that is created by spectral leakage from a strong transmit signal. Specifically, there is a need in the art for a cancellation method based on an alternative path that downconverts the RF noise in the receive (Rx) band to baseband, and then cancels the noise from the main receive signal in order to facilitate reception of the intended receive signal.

### SUMMARY

Embodiments disclosed herein provide a method for eliminating receive band noise in a communication system. The method comprises sensing a transmit signal at a receive frequency, wherein the signal sensed is a bleed over signal from a transmit signal. The sensed bleed over signal is then digitized using a secondary receiver. This secondary receiver utilizes a separate path from the primary receive path. The next step in the method is to estimate the linear distortion, delay, attenuation in the sensed bleed over signal. Next, compensation for the linear distortion, delay, and attenuation are performed on the sensed bleed over signal. The sensed, digitized, and compensated bleed over signal is then cancelled from the primary receive path.

A further embodiment to the method provides that the estimating is performed using a least mean squares algorithm.

An apparatus for eliminating receive band noise in a communication system is also provided in an additional embodiment. The apparatus includes a sensor for sensing a bleed over signal from a transmit signal; an analog to digital converter for digitizing the sensed bleed over signal using a secondary receiver. The secondary receiver is part of a diversity path that is separate from the primary receive path. A processor is also part of the apparatus and estimates linear distortion, delay, and attenuation in the sensed bleed over signal. A processor is also used for compensating for linear distortion, delay, and attenuation in the sensed bleed over signal. A process is then used to cancel the sensed, digitized, and compensated bleed over signal from the primary receive path.

A still further embodiment provides an apparatus for eliminating receive band noise in a communication system. The apparatus comprises: means for sensing a transmit signal at a receive frequency, where the signal sensed is a bleed over signal from a transmit signal. The apparatus also includes: means for digitizing the sensed bleed over signal via a secondary receiver, where the secondary receiver uses a separate receive path from the primary receive path; means for estimating linear distortion, delay, and attenuation in the sensed bleed over signal; means for compensating for linear distortion, delay, and attenuation in the sensed bleed over signal; and means for canceling the sensed, digitized, and compensated bleed over signal.

Yet a further embodiment provides a non-transitory computer readable storage medium containing instructions for causing a processor to perform the steps of: sensing a transmit signal at a receive frequency, wherein the sensing is a bleed over signal from a transmit signal; digitizing the sensed bleed over signal via a secondary receiver, wherein the secondary receiver utilizes a separate path from the primary receive path; estimating linear distortion, delay, and attenuation in the sensed bleed over signal; compensating for linear distortion, delay, and attenuation in the sensed bleed over signal; and canceling the sensed, digitized, and compensated bleed over signal from the primary receive path.

### BRIEF DESCRIPTION OF THE DRAWINGS

FIG. 1 illustrates a multiple access wireless communication system, in accordance with certain embodiments of the disclosure.

FIG. 2 illustrates a block diagram of a communication system in accordance with certain embodiments of the disclosure.

FIG. 3 is a diagram illustrating an embodiment of an apparatus for Rx-band noise cancellation installed in a wireless receiver device.

FIG. 4 is a flow diagram of a method for Rx-band noise cancellation according to an embodiment.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

As used in this application, the terms “component,” “module,” “system” and the like are intended to include a computer-related entity, such as, but not limited to hardware, firmware, a combination of hardware and software, software, or software in execution. For example, a component may be, but is not limited to being, a process running on a processor, a processor, an object, an executable, a thread of execution, a program and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a terminal, which can be a wired terminal or a wireless terminal. A terminal can also be called a system, device, subscriber unit, subscriber station, mobile station, mobile, mobile device, remote station, remote terminal, access terminal, user terminal, communication device, user agent, user device, or user equipment (UE). A wireless terminal may be a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem. Moreover, various aspects are described herein in connection with a base station. A base station may be utilized for communicating with wireless terminal(s) and may also be referred to as an access point, a Node B, or some other terminology.

Moreover, the term “or” is intended to man an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

The techniques described herein may be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network may implement a radio technology such as Universal Terrestrial Radio Access (UTRA), CDMA2000, etc. UTRA includes Wideband CDMA (W-CDMA). CDMA2000 covers IS-2000, IS-95 and technology such as Global System for Mobile Communication (GSM).

An OFDMA network may implement a radio technology such as Evolved UTRA (E-UTRA), the Institute of Electrical and Electronics Engineers (IEEE) 802.11, IEEE 802.16, IEEE 802.20, Flash-OFDAM®, etc. UTRA, E-UTRA, and GSM are part of Universal Mobile Telecommunication System (UMTS). Long Term Evolution (LTE) is a release of UMTS that uses E-UTRA. UTRA, E-UTRA, GSM, UMTS, and LTE are described in documents from an organization named “3^{rd} Generation Partnership Project” (3GPP). CDMA2000 is described in documents from an organization named “3^{rd} Generation Partnership Project 2” (3GPP2). These various radio technologies and standards are known in the art. For clarity, certain aspects of the techniques are described below for LTE, and LTE terminology is used in much of the description below. It should be noted that the LTE terminology is used by way of illustration and the scope of the disclosure is not limited to LTE. Rather, the techniques described herein may be utilized in various application involving wireless transmissions, such as personal area networks (PANs), body area networks (BANs), location, Bluetooth, GPS, UWB, RFID, and the like. Further, the techniques may also be utilized in wired systems, such as cable modems, fiber-based systems, and the like.

Single carrier frequency division multiple access (SC-FDMA), which utilizes single carrier modulation and frequency domain equalization has similar performance and essentially the same overall complexity as those of an OFDMA system. SC-FDMA signal may have lower peak-to-average power ration (PAPR) because of its inherent single carrier structure. SC-FDMA may be used in the uplink communications where the lower PAPR greatly benefits the mobile terminal in terms of transmit power efficiency.

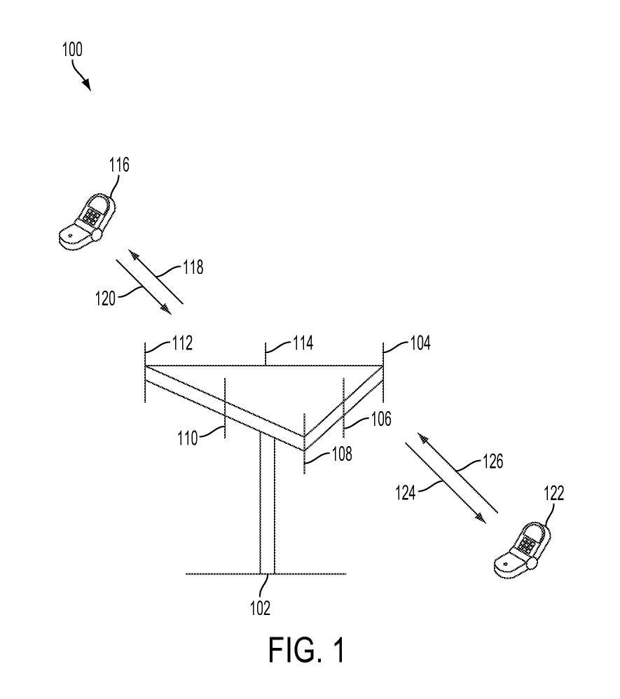

FIG. 1 illustrates a multiple access wireless communication system 100 according to one aspect. An access point 102 (AP) includes multiple antenna groups, one including 104 and 106, another including 108 and 110, and an additional one including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over downlink or forward link 118 and receive information from access terminal 116 over uplink or reverse link 120. Access terminal 122 is in communication with antennas 106 and 108, where antennas 106 and 108 transmit information to access terminal 122 over downlink or forward link 124 and receive information from access terminal 122 over uplink or reverse link 126. In a Frequency Division Duplex (FDD) system, communication links 118, 120, 124, and 126 may use a different frequency for communication. For example, downlink or forward link 118 may use a different frequency than that used by uplink or reverse link 120.

Each group of antennas and/or the area in which they are designed to communicate is often referred to as a sector of the access point. In an aspect, antenna groups each are designed to communicate to access terminals in a sector of the areas covered by access point 102.

In communication over downlinks or forward links 118 and 124, the transmitting antennas of access point utilize beamforming in order to improve the signal-to-noise ratio (SNR) of downlinks or forward links for the different access terminals 116 and 122. Also, an access point using beamforming to transmit to access terminals scattered randomly through its coverage causes less interference to access terminals in neighboring cells than an access point transmitting through a single antenna to all its access terminals.

An access point may be a fixed station used for communicating with the terminals and may also be referred to as a Node B, an evolved Node B (eNB), or some other terminology. An access terminal may also be called a mobile station, user equipment (UE), a wireless communication device, terminal, or some other terminology. For certain aspects, either the AP 102, or the access terminals 116, 122 may utilize the proposed Tx-echo cancellation technique to improve performance of the system.

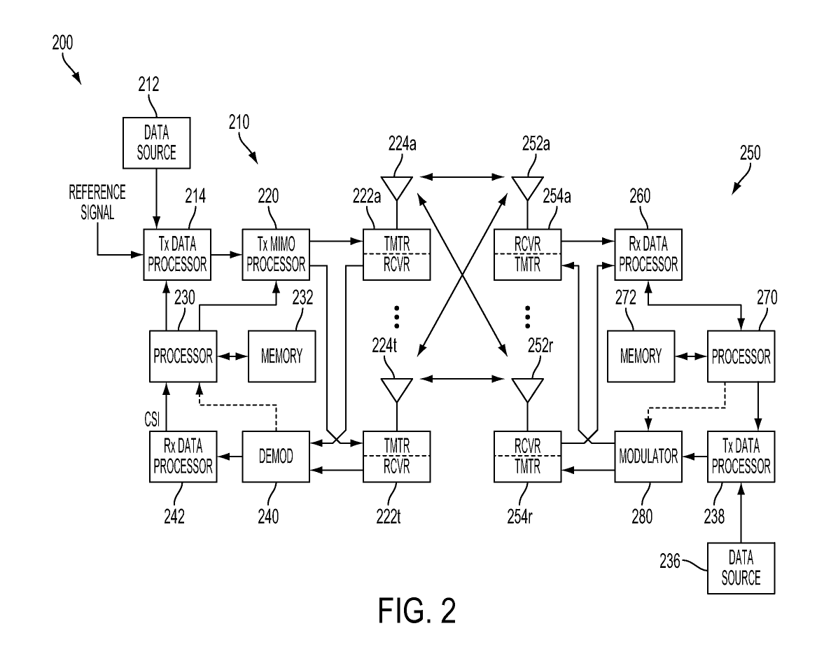

FIG. 2 is a block diagram of an aspect of a transmitter system 210 and a receiver system 250 in a MIMO system 200. At the transmitter system 210, traffic data for a number of data streams is provided from a data source 212 to a transmit (TX) data processor 214. An embodiment of the disclosure is also applicable to a wireline (wired) equivalent of the system shown in FIG. 2.

In an aspect, each data stream is transmitted over a respective transmit antenna. TX data processor 214 formats, codes, and interleaves the traffic data for each data stream based on a particular coding scheme selected for that data stream to provided coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (e.g., symbol mapped) based on a particular based on a particular modulation scheme (e.g. a Binary Phase Shift Keying (BPSK), Quadrature Phase Shift Keying (QPSK), M-PSK in which M may be a power of two, or M-QAM, (Quadrature Amplitude Modulation)) selected for that data stream to provide modulation symbols. The data rate, coding, and modulation for each data stream may be determined by instructions performed by processor 230 that may be coupled with a memory 232.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain aspects TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by the N_{R} antennas 252a through 252r and the received signal from each antenna 252 is provided to a respective receiver (RCVR) 254a through 254r. each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX processor 260 is complementary to that performed by TX MIMO processor 220 and TX data processor 214 at transmitter system 210.

Processor 270, coupled to memory 272, formulates a reverse link message. The reverse link message may comprise various types of information regarding the communication link and/or the received data stream. The reverse link message is then processed by a TX data processor 238, which also receives traffic data for a number of data streams for ma data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240 and processed by a RX data processor 242 to extract the reserve link message transmitted by the receiver system 250.

Embodiments disclosed herein describe a method and apparatus to cancel noise in the receive channel that is created by spectral leakage from a strong transmit signal. the cancellation method is based on an alternative path that downconverts the RF noise in the Rx band to baseband and then cancels the noise from the main receive signal in order to facilitate reception of the intended receive signal. Cancellation may be explicit (via subtraction after channel estimation), or may be implicit and accomplished through the inherent property of the minimum mean square estimation (MMSE) or zeroing function (ZF) Rx diversity receiver that cancels first rank interference.

Embodiments described herein provide a slowly adaptive technique (weak time dependence), which allows cancellation of excessive Rx band noise that is causes when the transmit signal presents excessive out of band emissions that are located within the receive frequency band and obscure reception of a desired downlink signal. Normally, transmit techniques and multiple filters, both on the chip itself and in the duplexer, as well as, potentially, surface acoustic wave (SAW) filters control receive band noise so that the noise is approximately 10 dB or more below the thermal noise floor. At those levels the noise minimally affects receive band sensitivity. As the receive band noise approaches thermal noise levels, it becomes a serious source of degradation.

One way to deal with the noise is to add additional filtering. However, the resulting increases in size, cost, and insertion loss to the main transmit power, make this option unacceptable in many applications.

Excessive receive band noise may occur due to truly excessive transmit out of band emissions. These emissions may lack structure. Examples include phase noise from the transmit local oscillator or noise from the power amplifier. The noise may also have structure, as would be found with intermodulation products. The noise may also be a mixture of structured and unstructured components. Excessive receive band noise may also be caused by limited filtering of the receive band leakage from transmit to receive chains. An example is a duplexer with insufficient receive band isolation.

Embodiments described herein provide a method of adaptive receive band noise cancellation that uses an alternative receiver, such as a diversity receiver, or may use a separate, second receive chain. The second receive chain may have a much smaller dynamic range requirement than a normal receive path and samples the receive band noise and then cancels it from the primary receive chain. This method uses an alternative receive band path that taps the receive band noise, reconstructs that noise as it impinges the affected receive chain, and then cancels the noise. In effect, embodiments “steal” the alternative receive chain to tap off the power amplifier, thus sensing the receive band noise as it occurs. The sensed receive band noise is then downconverted to baseband.

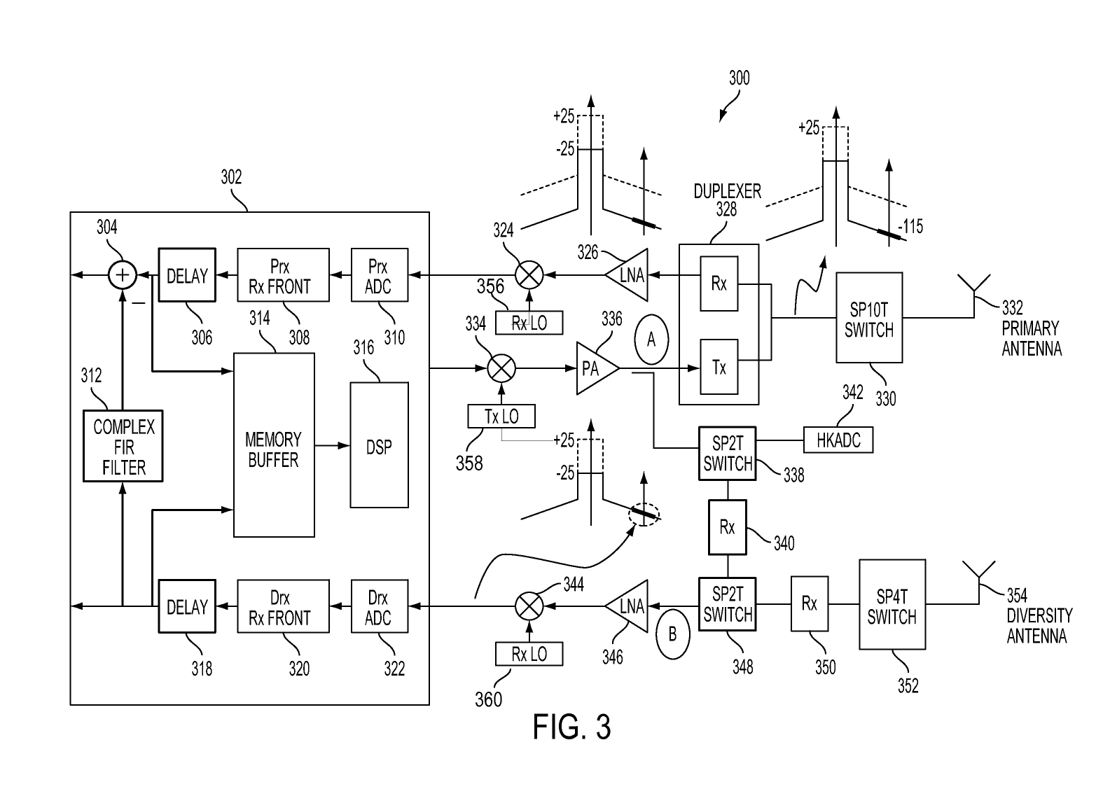

FIG. 3 illustrates the apparatus of an embodiment. The apparatus provides a primary receive chain as well as a diversity receive chain and a transmit chain. The primary receive chain operation begins when primary antenna 332 receives a signal. The received signal is passed through switch 330, which is a single pole ten-throw switch. After passing through the switch the received signal would appear on an oscilloscope as illustrated by the waveform shown above switch 3310. The signal is then passed through the duplexer 328, specifically the Rx section of the duplexer. After duplexing, the signal is passed to the low noise amplifier (LNA) 326. LNA 326 provides an input to mixer 324, along with the receive local oscillator (Rx LO) 356. The resulting output from the mixer 324 is passed into the assembly 302, which is in chip form. The first internal chip element is the primary Rx analog to digital converter (ADC) 310. ADC 310 passes the now digital signal to the primary receiver front end PRx front end, 308. PRx front end 308 passes the received signal to delay component 306. From delay component 306, the signal is passed to adder 304. The signal may also be passed to memory buffer 314. From the memory buffer signals may be sent to the digital signal processor (DSP) 316. Adder 304 also includes input from the complex finite impulse response (FIR) filer 312.

The embodiment also includes a diversity receive chain with similar elements. Specifically the diversity antenna 354 is used to receive signals. The received signals are passed to a single pole four throw switch 352. After switching operations, the signal is passed to Rx filter 350. The signal is then passed through single pole double throw switch 348. Switch 348 passes the receive signal to LNA 346. LNA passes the diversity Rx signal to the mixer 344 which mixes the Rx signal with input from the receive local oscillatory 360. This combined input is passed into chip assembly 302, specifically to the diversity ADC 322. The diversity receive chain ADC passes the now-digitized signal to the diversity receive front end 320. DRx 320 passes the signal to delay element 318. From delay element 318, the signal may be passed to complex FIR filter 312 or into memory buffer 314.

The transmit chain begins with the output of the chip assembly 302 being input to mixer 334, where the transmit (Tx) signal is mixed with the output of the Tx local oscillator 358. The output of mixer 334 is passed to power amplifier (PA) 336. At this point, point A, the signal may be passed to the Tx portion of duplexer 328, or to single pole double throw switch 338. If sent to the Tx portion of duplexer 328, the signal passes through single pole ten throw switch 330 and to primary antenna 332 for transmission. If the signal is diverted through a coupler at point A, the signal passes through a Rx filter 340 and from there through single pole double throw switch 348.

In use the apparatus operates as described below to cancel Rx band noise. The output of the PA 336, which is connected to the primary receive chain is coupled using switches 338 and 348 on the chip or circuit board and a receive filter 340, is coupled into the diversity chain. HKADC 342 is also coupled to the single pole double throw switch 338. The output is then downconverted to baseband and digitized by the diversity chain analog to digital converter 322. At this point in the method, there are two versions of the receive band noise, and both are at baseband frequency. One version is the receive band noise impinging on the primary receive chain and obscuring the desired receive signal and the other is the receive band noise as sensed by the directional coupler A at the power amplifier and downconverted and digitized through the diversity receive chain and analog to digital converter 322.

The two copies of the receive band noise are identical except for a scaling factor, that accounts for the fact that the receive band noise has not been through the significant attenuation of the transmit filter portion of the duplexer. However, the receive band noise has been attenuated by the directional coupler while being sensed from the power amplifier output. Another difference is a transfer function, which is the difference between the magnitude and phase frequency response of the receive filter used for the diversity receive band noise sense path and the magnitude and phase frequency response of the transmit to receive leakage path of the duplexer 328.

FIG. 3 illustrates the explicit cancellation mechanism, where the channel of the interference, namely the receive band noise, is estimated and then reconstructed and cancelled from the main receive path. This may be performed by the MMSE or other diversity receiver, which naturally rejects the receive band noise, as that noise is first rank noise, and thus looks the same of both receive paths, except for the scaling coefficients.

In operation, the baseband equivalent of the Rx baseband noise (Rx BN) at point of the FIG. 3 is denoted, then the signals received by the primary and diversity chains may be represented as:

rₚ(t)=d(t)+a·(hₚ(t)*x(t))+nₚ(t)

r_{d}(t)=b·(h_{d}(t)*x(t))+n_{d}(t)

where the desired signal d(t) in the primary receive chain is obscured by the independent noise nₚ(t) and the RxBN x(t), which has been attenuated and shaped by the transfer function bh_{d}(t) and observed under independent noise n_{d}(t).

The signal levels justify momentarily ignoring the noise n_{d}(t) masking the RxBN sensed by the diversity path. When the power amplifier transmits at maximum power, the Rx BN level is approximately 95 dBc or more below the transmit signal level and is therefore, harmless to the desired receive signal. This means that the RxBN is approximately −80 dBM, which is approximately 25 dB of RxBN sense signal to noise ratio, as the thermal floor for the diversity receive chain is approximately −105 dBm. The noise n_{d}(t) may be ignored, and as a result, the cancellation solution is to clean up the primary receive chain be removing the Rx BN, by subtracting a shaped appropriately attenuated and delayed version of the RxBN from the primary receive signal. The following equations describe the process:

f=a/b

h(t)=h_{d}⁻¹(t)*hₚ(t)

and ignoring the secondary noise n_{d}(t) because of very high signal to noise (SNR) ratio in the diversity path as described above, then the primary receive signal without the receive band noise is:

y(t)Δrₚ(t)−f·h(t)*r_{d}(t)=d(t)+nₚ(t)

which produces a signal for the primary receive chain that is roughly what the signal would have been had no receive band noise been present in the first place.

The above operations may be performed digitally, after analog to digital conversion of both the main receive path as well as the “RxBN sensing” path. An equivalent solution may be implemented before A/D conversion, where the estimation and adaption is performed using analog methods after downconversion of the intended receive band and receive band noise to baseband, thus saving an A/D pair.

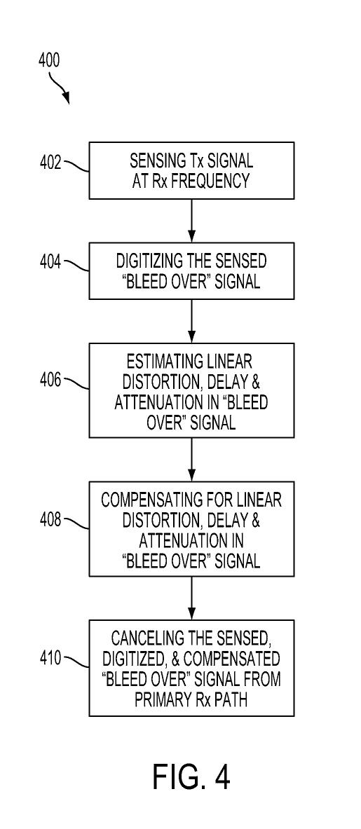

FIG. 4 provides a flowchart of the steps of the method, 400. The method begins at step 402, when the transmit (Tx) signal is sensed in the Rx frequency band. In step 404, the sensed “bleed over” signal is digitized. Next, in step 406, the linear distortion, delay, and attenuation in the “bleed over” signal are sensed. IN step 408, compensation is performed for the linear distortion, delay, and attenuation in the “bleed over signal.” Finally, at step 410, the sensed, digitized, and compensated “bleed over signal” is cancelled from the primary receive path.

It is under stood that the specific order or hierarchy of steps in the processes disclosed is an illustration of exemplary approaches. Based upon design preferences, it is understood that the specific order or hierarchy of steps in the processes may be rearranged. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method for eliminating receive band noise in a communication system, comprising:
sensing a transmit signal at a receive frequency, wherein the sensing is a bleed over signal from a transmit signal;
digitizing the sensed bleed over signal via a secondary receiver, wherein the secondary receiver utilizes a separate path from the primary receive path;
estimating linear distortion, delay, and attenuation in the sensed bleed over signal;
compensating for linear distortion, delay, and attenuation in the sensed bleed over signal; and
cancelling the sensed, digitized, and compensated bleed over signal from the primary receive path.

2. The method of claim 1, wherein the estimating uses a block least squares algorithm.

3. The method of claim 1, wherein the estimating uses a least mean squares algorithm.

4. The method of claim 1, wherein the estimating is done in an on-line adaptive technique.

5. The method of claim 1, wherein the estimating can be done on two blocks of data, one from a primary receive chain, and one from a secondary receive chain.

6. An apparatus for eliminating receive band noise in a communication system comprising:
a sensor for sensing a bleed over signal from a transmit signal;
an analog to digital converter for digitizing the sensed bleed over signal using a secondary receiver, wherein the secondary receiver is part of a diversity path separate from the primary receive path;
a processor for estimating linear distortion, delay, and attenuation in the sensed bleed over signal;
a processor for compensating for linear distortion, delay, and attenuation in the sensed bleed over signal; and
a processor for cancelling the sensed, digitized, and compensated bleed over signal from the primary receive path.

7. The apparatus of claim 6, where the processor for estimating linear distortion, delay, and attenuation, in the sensed bleed over signal, the processor for compensating for linear distortion, delay, and attenuation in the sensed bleed over signal, and the processor for cancelling the sensed, digitized, and compensated bleed over signal from the primary receive path, are combined in one processor.

8. An apparatus for eliminating receive band noise in a communication system, comprising:
means for sensing a transmit signal at a receive frequency, wherein the sensing is a bleed over signal from a transmit signal;
means for digitizing the sensed bleed over signal via a secondary receiver, wherein the secondary receiver utilizes a separate path from the primary receive path;
means for estimating linear distortion, delay, and attenuation in the sensed bleed over signal;
means for compensating for linear distortion, delay, and attenuation in the sensed bleed over signal; and
means for cancelling the sensed, digitized, and compensated bleed over signal from the primary receive path.

9. The apparatus of claim 8, wherein the means for estimating uses a block least squares algorithm.

10. The apparatus of claim 8, wherein the means for estimating uses a least mean squares algorithm.

11. The apparatus of claim 8, wherein the means for estimating performs an on-line adaptive technique.

12. The apparatus of claim 8, wherein the means for estimating operates on two blocks of data, one from the primary receive chain and one from the secondary receive chain.

13. A non-transitory computer readable storage medium containing instructions for causing a processor to perform the steps of:
sensing a transmit signal at a receive frequency, wherein the sensing is a bleed over signal from a transmit signal;
digitizing the sensed bleed over signal via a secondary receiver, wherein the secondary receiver utilizes a separate path from the primary receive path;
estimating linear distortion, delay, and attenuation in the sensed bleed over signal;
compensating for linear distortion, delay, and attenuation in the sensed bleed over signal; and
cancelling the sensed, digitized, and compensated bleed over signal from the primary receive path.

14. The non-transitory computer readable storage medium of claim 13, further containing instructions for estimating using a block least squares algorithm.

15. The non-transitory computer readable storage medium of claim 13, further containing instructions for estimating using a least mean squares algorithm.

16. The non-transitory computer readable storage medium of claim 13, further containing instructions for estimating using an on-line adaptive technique.

17. The non-transitory computer readable storage medium of claim 13, further containing instructions for estimating using two blocks of data, one from a primary receive chain and one from a secondary receive chain.
